(19) United States
(12) Patent Application Publication
(10) Pub. No.: US 2004/0101396 A1
(43) Pub. Date: May 27, 2004

(54) Method for regulating a steam turbine, and corresponding steam turbine

(76) Inventors: Heinrich Oeynhausen, Muelheim A D Ruhr (DE); Richard Steinborn, Leverkusen (DE); Heribert Werthes, Essen (DE)

Correspondence Address: STAAS & HALSEY LLP, SUITE 700, 1201 NEW YORK AVENUE, N.W., WASHINGTON, DC, 20005, US

(21) Appl. No.: 10/380,911

(22) PCT Filed: Sep. 7, 2001
(86) PCT No.: PCT/EP01/10358

(51) Int. Cl. F03D 1/00

(52) U.S. Cl. 415/1

(57) ABSTRACT

The invention relates to a method for regulating a steam turbine (1), according to which steam is fed to the steam turbine (1) via at least three valves, whereby one of the valves is regulated as a regulating valve (9, 11), and at least two valves are controlled as control valves (13, 15).

The invention relates to a method for controlling a steam turbine, in which steam is supplied to the steam turbine via at least three valves. The invention also relates to a steam turbine having a valve group for controlling the steam inlet.

A method for controlling a steam turbine is disclosed in the article “Praxisgerechte Auslegung von Drehzahl und Leistungsreglern für Dampfturbinen” [Practical design of the rotation speed and power regulators for steam turbines] by Johannes Dastych and Heinz Unbehauen, Martin Bennauer and Heribert Werthes, ATP 41 (1999), Issue 5. A steam turbine is controlled on the basis of its rotation speed or power. The control loop for the rotation speed and power, as shown in FIG. 2, comprises function blocks such as a rotation speed/power regulator (D-/LR), a fresh steam control valve (FD-STV), a catchment control valve (AF-STV), a steam generator (DE) and a turbine (T) as well as elementary blocks, such as a constant, a ramp and a step function for the input signals. In order to provide electrical power, the turbine set is supplied with steam from a steam generator, with the steam supply being controlled via control valves such that the necessary power is available. The rotation speed and the power are controlled via a common rotation speed/power regulator both for on-load operation with a selectable steady state and for regulating the rotation speed when on no load. The output signal from the rotation speed/power regulator acts on the fresh steam and catchment control valves. Controlling a steam turbine in this way requires a very complex control loop as well as control valves which allow sufficiently fast control actions. Until now, hydraulically driven control valves have been used exclusively for steam inlet control, since a hydraulic drive such as this is the only way to adjust the valve travel sufficiently quickly.

A control drive for a valve for a steam turbine with an electric motor drive is known from WO98/13633. An electric motor drive such as this is particularly cost-effective and, furthermore, reduces the risk of fire by avoiding the use of hydraulic oil. An electric motor drive such as this for a steam valve can be used for a quick-action closing valve for a steam turbine, in which all that is required is for the steam line to be closed quickly. However, electric motor drives are not suitable for steam turbine control since the control times are too short and the valve travel settings too inaccurate for the necessary valve travel control actions.

The object of the invention is to specify a method for controlling a steam turbine which, in particular, is very cost-effective and, in addition, offers improved operational reliability and safety. A further object of the invention is to specify a steam turbine with the same advantages.

According to the invention, the object with regard to a method is achieved by specifying a method for controlling a steam turbine, in which steam is supplied to the steam turbine via at least three valves, with one of the valves being regulated as a regulating valve, and at least two valves being controlled as control valves.

A completely new approach is thus proposed, in which valves of two different categories can be used for controlling a steam turbine. The invention is in this case based on the knowledge that the valves do not all need to be in the form of regulating valves for efficient, safe, reliable and fast control of the steam turbine, as has been normally believed until now. In fact, after extensive tests, it has been possible to show that a combination of regulating valves and control valves actually allows the steam turbine to be controlled sufficiently reliably, safely and quickly. The valve travels of the control valves are in this case set to a specific value as a function of a regulator output signal. The maintenance of a control difference value of approximately zero is carried out by one, or possibly more, regulating valves. At least two regulating valves can thus be replaced by very much simpler control valves, thus considerably simplifying the control loop.

A) The control valves are preferably driven by electric motors. An electric motor drive offers considerable cost advantages over, for example, an electrohydraulic drive. Furthermore, the fire risk is reduced by the lack of hydraulic oil. By using the regulating valve for fine control, the poorer control dynamics of the electric motor drive are also sufficient for use in the control process.

B) Two regulating valves and two control valves are preferably used. Four valves are normally used for control processes in the steam turbine. In principle, on the basis of the new control concept, one regulating valve, which interacts with three control valves, is sufficient. However, in order to achieve better availability, it is advantageous to use two regulating valves and two control valves.

C) The method with regard to power consumption of the steam turbine is preferably configured such that the regulating valve is opened first of all, and one of the control valves is opened when a regulator output signal, which is used for regulating the regulating valve, exceeds a fixed first value and a positive control difference is present. The first value is more preferably approximately one quarter of the maximum regulator output signal. The positive control difference indicates that the desired value for the power or else for the rotation speed has not yet been reached.

D) The second regulating valve more preferably opens when the regulator output signal exceeds a second value and a positive control difference is present. The second value of the regulator output signal is in this case greater than the first value of the regulator output signal. A further power consumption step is thus reached, in which the third valve, to be precise the second regulating valve, is opened. The second value of the regulator output signal is in this case more preferably about half the maximum value of the regulator output signal.

E) The second control valve preferably opens when the regulator output signal exceeds a third value and a positive control difference is present. The third value of the regulator output signal is in this case greater than the value of the second value of the regulator output signal. A further power consumption step for the steam turbine is thus reached, at which the second control valve is opened. A regulator output signal of 100% results in all the valves being opened completely.

F) A closing rate for each of the control valves is preferably set as a function of the respective magnitude of the control difference. As stated, the control difference indicates the difference between the nominal value and the actual value of the rotation speed, or of the power, of the steam turbine. If the control difference is large, the control valves are moved at high speed to their nominal position. If the control difference is smaller, a slower control rate is sufficient. In particular, for electric motor drives, a frequency converter can predetermine the actuating direction for the regulating valves as a function of the mathematical sign of the control difference.

The refinements according to points A to F may be combined with one another in any desired manner.

The object with regard to a steam turbine is achieved according to the invention by specifying a steam turbine having a valve group for controlling the steam inlet, which valve group has a regulating valve and at least two control valves.

The advantages of such a steam turbine correspond, on the basis of what has been stated above, with the advantages of the method for controlling a steam turbine.

The control valves preferably have an electric motor drive.

The invention will be explained in more detail by way of example with reference to the drawing in which, shown schematically and not to scale:

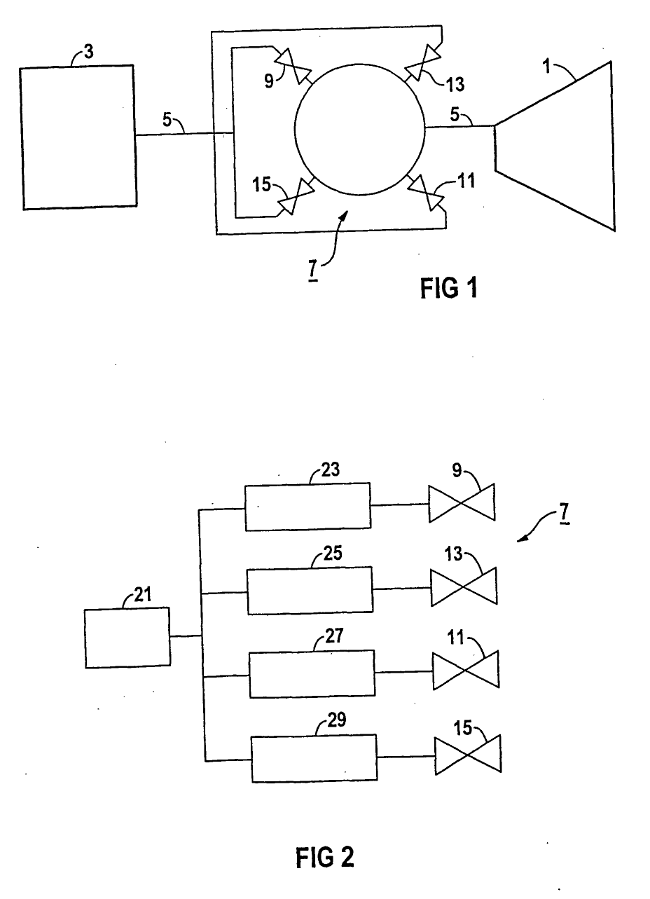

FIG. 1 shows a steam turbine system,

FIG. 2 shows a set of steam inlet valves with associated control circuitry, and

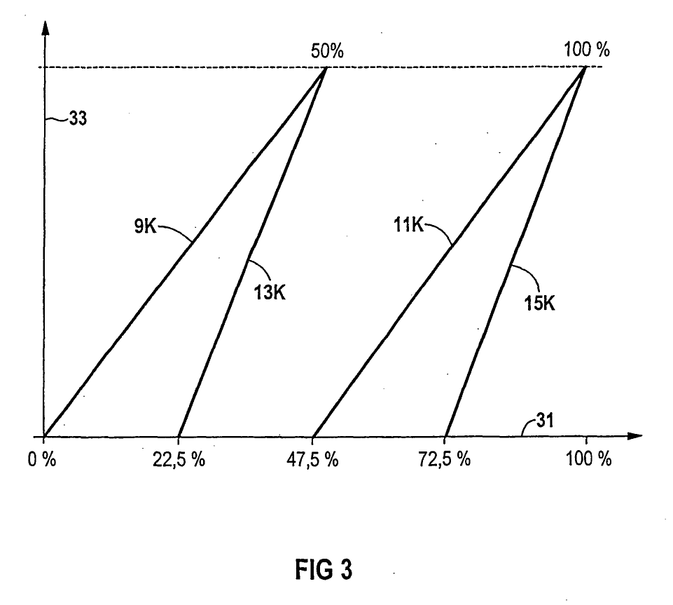

FIG. 3 shows an illustration of the characteristics for the steam inlet valves.

The same reference symbols have the seam meanings in the various figures.

FIG. 1 shows, schematically, a steam turbine system. A steam turbine 1 is supplied with steam from a steam generator 3 via the supply line 5. A valve group 7 is installed in the supply line 5. The valve group 7 has a first regulating valve 9 and a second regulating valve 11. The valve group 7 also has a first control valve 13 and a second control valve 15. The amount of steam introduced into the steam turbine 1 is controlled via the valve group 7. This is done as a function of the power or rotation speed desired for the steam turbine 1. This will be explained in more detail with reference to FIGS. 2 and 3.

FIG. 2 shows the valve group 7 from FIG. 1 with the associated control circuitry. A regulator 21 produces a regulator output signal, characterizing a control difference, as a function of the actual value of the rotation speed or power and the nominal value of the rotation speed or power. The regulator output signal is supplied to a first servo amplifier 23 for the first regulating valve 9. The regulator output signal is also supplied to a second servo amplifier 27 for the second regulating valve 11. The regulator output signal is also supplied to a first frequency converter 25 for the first control valve 13. The regulator output signal is also supplied to a second frequency converter 29 for the second control valve 15. The control method will be described in more detail with reference to FIG. 3.

FIG. 3 uses a graph to show, by way of example, the valve travel of each of the valves 9, 11, 13, 15 as a function of the regulator output signal. The details are given as a percentage of the respective maximum value. The characteristic 9K indicates the profile of the valve travel 33 of the first regulator valve 9 as a function of the regulator output signal 31. The characteristic 13K indicates the corresponding characteristic for the first control valve 13. The characteristic 11K indicates the corresponding characteristic for the second regulating valve 11. The characteristic 15K indicates the corresponding characteristic for the second control valve 15. The first regulating valve 9 opens in proportion to the magnitude of the regulator output signal 31. The first control valve 13 opens when the regulator output signal 31 reaches a value of 22.5%. The valve travel 33 for the first regulating valve 9 and for the first control valve 13 is 100% when the value of the regulator output signal 31 is 47.5%. Beyond this point, the second regulating valve 11 opens. Finally, the second control valve 15 is opened at a value of 72.5%. All the valves 9, 11, 13, 15 are completely open when the regulator output signal 31 reaches a value of 100%. The starting process, acceleration to the rated rotation speed and synchronization take place using the first regulating valve 9. The magnitude of the control difference governs the rate at which the control valves 13, 15 open. During load shedding, a negative control difference occurs. The magnitude of the negative control difference governs the rate at which the control valves close. Owing to the poorer control dynamics of the control valves, which are driven by electric motors in the illustrated example, the response value for a switching process of “close” during load shedding may differ for the regulating valves 9, 11 and for the control valves 13, 15.

1. A method for controlling a steam turbine (1),
in which steam is supplied to the steam turbine (1) via at least three valves (9, 11, 13, 15), with one of the valves (9, 11) being regulated as a regulating valve and at least two valves (13, 15) being controlled as control valves, and with the regulating valve (9, 11) opening first of all for power consumption by the steam turbine (1), and with one of the control valves (13, 15) opening when a fixed first value for a regulator output signal (31), which is used for regulating the regulating valve (9, 11), is exceeded and a positive control difference is present, with the control valves (13, 15) being driven by electric motors.

2. The method as claimed in claim 1,
in which two regulating valves (9, 11) and two control valves (13, 15) are used.

3. The method as claimed in claims 1 and 2,
in which the second regulating valve (11) opens when the regulator output signal (31) exceeds a second value and a positive control difference is present.

4. The method as claimed in claims 1 and 2,
in which the second control valve (15) opens when the regulator output signal (31) exceeds a third value and a positive control difference is present.

5. The method as claimed in claim 1,
in which a closing rate for each of the control valves (13, 15) is set as a function of the respective magnitude of the control difference.

6. A steam turbine (1) having a valve group (7) for controlling the steam inlet, which valve group (7) has a regulating valve (9, 11) and at least two control valves (13, 15).

7. The steam turbine (1) as claimed in claim 6, in which the control valves (13, 15) have an electric motor drive.
